(19) United States
(12) Patent Application Publication
(10) Pub. No.: US 2012/0292899 A1
(43) Pub. Date: Nov. 22, 2012

(54) Hydraulic Coupling Member With Dual Electrical Bonding Contacts

(75) Inventor: Robert E. Smith, III, Missouri City, TX (US)

(73) Assignee: NATIONAL COUPLING COMPANY, INC., Stafford, TX (US)

(21) Appl. No.: 13/563,191

(22) Filed: Jul. 31, 2012

Related U.S. Application Data
(62) Division of application No. 12/612,502, filed on Nov. 4, 2009.

(51) Int. Cl. F16L 55/00; F16L 21/00

(52) U.S. Cl. 285/119

(57) ABSTRACT

A hydraulic coupling member is equipped with dual, electrically conductive contacts one of which is configured to contact a junction plate or junction plate holding the coupling member while the other is configured to contact an opposing coupling member when the coupling is fully made up thereby electrically bonding the coupling system.

### CROSS-REFERENCE TO RELATED APPLICATIONS

This application for patent is a divisional application of U.S. patent application Ser. No. 12/612,502 filed Nov. 4, 2009, the disclosure of which is hereby incorporated by reference in its entirety.

### STATEMENT REGARDING FEDERALLY SPONSORED RESEARCH OR DEVELOPMENT

None

### BACKGROUND OF THE INVENTION

1. Field of the Invention

This invention relates to hydraulic couplings. More particularly, it relates to undersea hydraulic couplings used in systems which employ electrical bonding of components.

2. Description of the Related Art

A wide variety of undersea hydraulic couplings are available. Some couplings employ metal seals. Examples of undersea hydraulic couplings having metal seals include U.S. Pat. No. 4,694,859 for “Undersea hydraulic coupling and metal seal” U.S. Pat. No. 4,817,668 for “Integral metal seal for hydraulic coupling” U.S. Pat. No. 4,884,584 for “Internally preloaded metal-to-metal seal hydraulic connector” U.S. Pat. No. 5,029,613 for “Hydraulic coupler with radial metal seal” U.S. Pat. Nos. 5,099,882 and 5,203,374 for “Pressure balanced hydraulic coupling with metal seals” U.S. Pat. No. 5,284,183 for “Hydraulic coupler with radial metal seal” U.S. Pat. No. 5,339,861 for “Hydraulic coupling with hollow metal o-ring seal” U.S. Pat. No. 5,355,909 for “Undersea hydraulic coupling with metal seals” U.S. Pat. No. 5,979,499 for “Undersea hydraulic coupling with hollow metal seal” U.S. Pat. No. 6,962,347 for “Metal backup seal for undersea hydraulic coupling” and U.S. Pat. No. 7,021,677 for “Seal retainer with metal seal members for undersea hydraulic coupling” all to Robert E. Smith III and assigned to National Coupling Company of Stafford, Tex.

Other undersea hydraulic couplings employ only “soft seals”—i.e., non-metal seals that are typically formed of an elastomeric polymer (“elastomer”) or an engineering plastic capable of being machined such as polyetheretherketone (“PEEK”) or DELRIN® acetal resin.

By way of example, U.S. Pat. No. 6,123,103 discloses a pressure balanced hydraulic coupling for use in undersea drilling and production operations. The coupling has radial passages connecting between the male and female members such that fluid pressure is not exerted against the face of either member during coupling or uncoupling. The female member has a split body with a first part and a second part, each having a longitudinal passage and a radial fluid passage. A radial seal is positioned on the junction between the first and second parts of the female member body to facilitate removal and replacement of the radial seal when the split body is disassembled. The male member may be inserted through the first and second parts of the female coupling member, thereby establishing fluid communication between the coupling members in a direction transverse to the coupling member bores.

U.S. Pat. No. 6,179,002 discloses an undersea hydraulic coupling having a radial pressure-energized seal with a dovetail interfit with the coupling body. The seal has a pair of flexible sealing surfaces for sealing with the male and female coupling members and a cavity therebetween that is exposed to fluid pressure in the coupling. The outer circumference of the seal has a dovetail interfit between inclined shoulders in the female member bore and on a seal retainer that holds the seal in the bore.

U.S. Pat. No. 6,575,430 discloses an undersea hydraulic coupling member having a ring-shaped seal with multiple scaling surfaces extending radially inwardly therefrom. The multiple sealing surfaces help guide the probe of the male coupling member into the female member without the risk of drag or galling of the receiving chamber. The seal has an interfit with reverse inclined shoulders in the female member to restrain the seal from moving radially inwardly due to vacuum or low pressure. Attention is invited in particular to the embodiments shown in FIGS. 8 and 9 of this patent.

U.S. Pat. No. 6,923,476 discloses a floating seal for an undersea hydraulic coupling member that is moveable radially to seal with the male coupling member even if there is some misalignment with the female coupling member. The floating seal is restricted from axial movement within the female coupling member receiving chamber. The floating seal may seal with the female coupling member.

U.S. Patent Application Publication No. US 2005/0029749 discloses an undersea hydraulic coupling member having a bore liner that protects the coupling members from galling during assembly or disassembly. The bore liner is removable from the bore of a female undersea hydraulic coupling member. The bore liner may be integral with a seal section that may seal with a male undersea hydraulic coupling member. The bore liner also may have an outer diameter configured to engage and interlock with the bore in which the bore liner is positioned. In certain embodiments, the bore liner is fabricated from PEEK.

In practice, undersea hydraulic coupling members are often mounted on manifold or junction plates which hold a plurality of coupling members. Coupling make-up is accomplished by moving a pair of substantially parallel junction plates with coupling members mounted thereon toward one another. In the subsea environment, this is often accomplished with the aid of remotely operated vehicles (ROV's).

U.S. Patent Publication No. 2005/0072573 by Robert E. Smith III discloses an undersea hydraulic coupling configured for use with manifold plates. This hydraulic coupling comprises tails on both the male and female members to allow insertion through and attachment to manifold plates. The tails on the hydraulic coupling members are provided with substantially rigid positioning members to allow the coupling members to be held in a nominal position with respect to the manifold plate, thereby preventing galling when the coupling members are mated, and further preventing unnecessary crimping or pressure weakened points at the connection of the tail to hydraulic lines.

U.S. Pat. No. 6,471,250 discloses an apparatus for moving together simultaneously male and female coupling members attached to manifold or junction plates. The apparatus includes a sloped cam surface on the first or lower junction plate, and a central shaft having a cam follower that moves up the sloped cam surface to urge the two junction plates together, and thereby connect male and female coupling members.

U.S. Pat. No. 7,083,201 discloses a junction plate assembly for undersea hydraulic couplings that includes an apparatus for simultaneously moving male and female coupling members attached to the junction plate together or apart. This apparatus includes sloped cam surfaces on the first or rear junction plate, a central shaft having cam followers that move up the sloped cam surface to urge the two junction plates together, and thereby connect male and female coupling members and corresponding sloped cam surfaces on the opposite side of the first junction plate with cam followers that move across the sloped cam surface to disconnect the coupling members.

U.S. Pat. No. 7,219,932 also discloses a junction plate for subsea hydraulic couplings. This junction plate assembly has gear-driven cam followers on the circumference of one, generally circular junction plate and curved cam tracks on a corresponding junction plate to urge the plates together or apart. The gears can provide significant mechanical advantage in moving the junction plates. Accordingly, larger junction plates with a greater number of hydraulic coupling members may be joined together when using this apparatus. The mechanical advantage provided by the junction plate mechanism allows the use of smaller, less powerful ROV's to make hydraulic connections in the subsea environment.

U.S. Pat. No. 4,915,419 discloses a sliding lock plate for hydraulic connectors. This apparatus for locking together simultaneously one or more male and female coupling members (primarily for use in undersea hydraulic applications) comprises a sliding lock plate supported by a first junction plate, the plate being slideable perpendicular to the coupling axis between an unlocked position and a locked position. The sliding lock plate has a number of passages configured to receive each coupling member therethrough in the unlocked position. In the locked position, the passages are configured to engage the circumference of the male and female coupling members and restrict axial movement of the members.

It has been found in practice that both hydraulic couplings and the junction or manifold plates holding them should be electrically bonded.

Bonding refers to the connection of all metal objects such as pipes, conduits and structural steel together to form an equipotential zone. Often, bonding includes an electrical connection to earth (ground potential). To remove dangerous voltage from ground faults, metal parts of electrical raceways, cables, enclosures, and equipment must be bonded to an effective ground-fault current path with an equipment grounding (bonding) conductor of a suitable type.

Equipment bonding provides an effective electrically continuous path in an effort to conduct stray voltage/current safely to ground. The National Electrical Code also states that it is good practice to bond all metallic systems and objects.

Bonding requirements and tests are intended to ensure that a system or facility is free from such hazards as electrical shock and static discharge. In addition, bonding requirements provide for reliable fault clearing paths and the suppression of electromagnetic interference (EMI). A typical bonding requirement might require that the chassis or structure of all equipment which is operating from a common power source shall be bonded such that maximum electrical fault currents can be conducted without creating a thermal or electrical hazard and that electrical bonds between all equipment shall be made to minimize differences in potential.

Bonding reduces electrostatic EMI by preventing the build-up and subsequent discharge of static charges. Bonding prevents surfaces from electrically resonating and radiating EMI. Bonding eliminates harmonic EMI by eliminating current rectification at contact surfaces. Bonding assures that all parts are at the same potential which prevents higher RF current flow in one part of the structure than another.

Cathodic protection is a technique used to control the corrosion of a metal surface by making that surface the cathode of an electrochemical cell. Cathodic protection systems are most commonly used to protect steel structures, water and fuel pipelines and storage tanks; steel pier piles, ships, offshore oil platforms and onshore oil well casings. Cathodic protection is an effective method of preventing stress corrosion cracking.

Galvanic or sacrificial anodes are made in various shapes typically using alloys of zinc, magnesium and aluminum. The electrochemical potential, current capacity, and consumption rate of these alloys are advantageous for cathodic protection.

Galvanic anodes are designed and selected to have a more negative electrochemical potential than the metal of the structure (typically steel). For effective cathodic protection, the potential of the steel surface is polarized more negative until the surface has a uniform potential. At that stage, the driving force for the corrosion reaction is halted. The galvanic anode continues to corrode, consuming the anode material until eventually it must be replaced. The polarization is caused by the current flow from the anode to the cathode. The driving force for the cathodic protection current flow is the difference in electrochemical potential between the anode and the cathode.

For larger structures, galvanic anodes cannot economically deliver enough current to provide complete protection. Impressed Current Cathodic Protection (ICCP) systems use anodes connected to a DC power source (a cathodic protection rectifier). Anodes for ICCP systems may be tubular and solid rod shapes or continuous ribbons of various specialized materials. These include high silicon cast iron, graphite, mixed metal oxide, platinum and niobium coated wire and others. In any cathodic protection system, bonding is required to provide a current path and achieve a uniform surface potential.

Electrical bonding is not always assured in an hydraulic coupling. This is especially true if the coupling has only soft seals and no metal seals since the male probe may not make metal-to-metal contact with the body of the female member. Not all couplings employ poppet valves with their associate actuators which contact one another when the coupling is made up. Moreover, many hydraulic fluids are dielectrics—an electrical insulator—and a thin film of hydraulic fluid on the surface of a part may prevent electrical continuity with an adjacent part.

To remedy this situation, designers often specify bonding straps to provide a low-impedance electrical pathway from one side of a coupling to the other. Such straps may be connected to the coupling bodies with clamps or, in some cases, machine screws which fit into threaded holes in the coupling body. These devices however, significantly increase the work required to make up and disconnect a hydraulic coupling. Particularly in the undersea environment where such work must be performed by remotely operated vehicles (ROVs) this is a significant disadvantage. What is needed is an hydraulic coupling which is electrically bonded to its mounting plate and which automatically electrically bonds the male and female members together upon make up. The present invention solves this problem.

### BRIEF SUMMARY OF THE INVENTION

An hydraulic coupling member is equipped with dual electrical contacts which assure electrical bonding to both a mating coupling member and a junction plate holding the coupling member. The dual electrical contacts may be incorporated in either a male or a female coupling member. Another aspect of the invention is a single electrical contact in a coupling member that is configured to provide electrical bonding between the coupling member and a junction or manifold plate holding the coupling member.

A bonding device according to the present invention may comprise an electrically conductive resilient member housed partially within a cavity on an external surface of the coupling member and projecting therefrom. In a first embodiment, the contact is formed from a portion of the resilient member. In a second embodiment, the contact and resilient member are separate elements in electrical contact with one another and with the body of the coupling member. When the coupling is made up, the contact at least partially retracts into the cavity so as to avoid interfering with full engagement of the coupling members.

### BRIEF DESCRIPTION OF THE SEVERAL VIEWS OF THE DRAWING(S)

FIG. 1 is a cross-sectional view of a female hydraulic coupling member having dual bonding devices according to a first embodiment.

FIG. 2 is a cross-sectional view of a male hydraulic coupling member having a bonding device according to a first embodiment.

FIG. 3 is a cross-sectional view of a fully made-up hydraulic coupling wherein the male and female members have bonding devices according to a second embodiment.

FIG. 4 is a cross-sectional view of a female hydraulic coupling member having dual bonding devices according to a second embodiment.

FIG. 5 is a cross-sectional view of a male hydraulic coupling member having a bonding device according to a second embodiment.

FIG. 6 is a cross-sectional view of a second type of a female hydraulic coupling member having dual bonding devices according to a third embodiment.

FIG. 7 is a cross-sectional view of a male hydraulic coupling member having a bonding device according to a third embodiment.

FIG. 8 is a cross-sectional view of a female hydraulic coupling member having a single bonding device according to a second embodiment.

FIG. 9 is a cross-sectional view of a male hydraulic coupling member having dual bonding devices according to a second embodiment.

### DETAILED DESCRIPTION OF THE INVENTION

The invention may best be understood by reference to various embodiments thereof. For purposes of illustration, the invention is shown in the drawing figures incorporated in a particular hydraulic coupling having novel smooth bore poppet valves in both the male and female members. An hydraulic coupling of this type is disclosed in full in U.S. patent application Ser. No. 12/140,087 by Robert E. Smith III filed Jun. 16, 2008, and entitled “Hydraulic Coupling with Smooth Bore Poppet” the disclosure of which is hereby incorporated by reference in its entirety. It will be appreciated by those skilled in the art that the practice of the invention is not limited to hydraulic couplings of the type shown in the drawing figures but may be employed in any coupling having suitable surfaces for mounting the electrical contacts.

U.S. patent application Ser. No. 11/683,724 by Robert E. Smith III filed Mar. 8, 2007, and entitled: “Hydraulic Coupling Member with Electrical Bonding Contactor” discloses an apparatus that provides electrical bonding between the male and female members of an hydraulic coupling when the coupling is made-up. The disclosure of this patent application is hereby incorporated by reference in its entirety. In practice, it has been found that, when hydraulic coupling members are mounted on a manifold plate, junction plate, tubing hanger or the like, it is desirable to additionally provide electrical bonding between the mounting plate and the coupling members installed therein in order to achieve effective, system-wide electrical bonding. This is particularly true for subsea junction plates which provide an oversized mounting hole for the coupling members. Such oversized holes allow the coupling members to self-align to a limited extent during coupling make-up, but may not provide a sufficiently tight connection to achieve electrical bonding. To overcome this situation, some operators have made use of conductive bonding straps attached at a first end to the junction plate and screwed (or otherwise conductively attached) to a coupling member at a second end. This practice significantly complicates the installation process. The subject invention solves this problem.

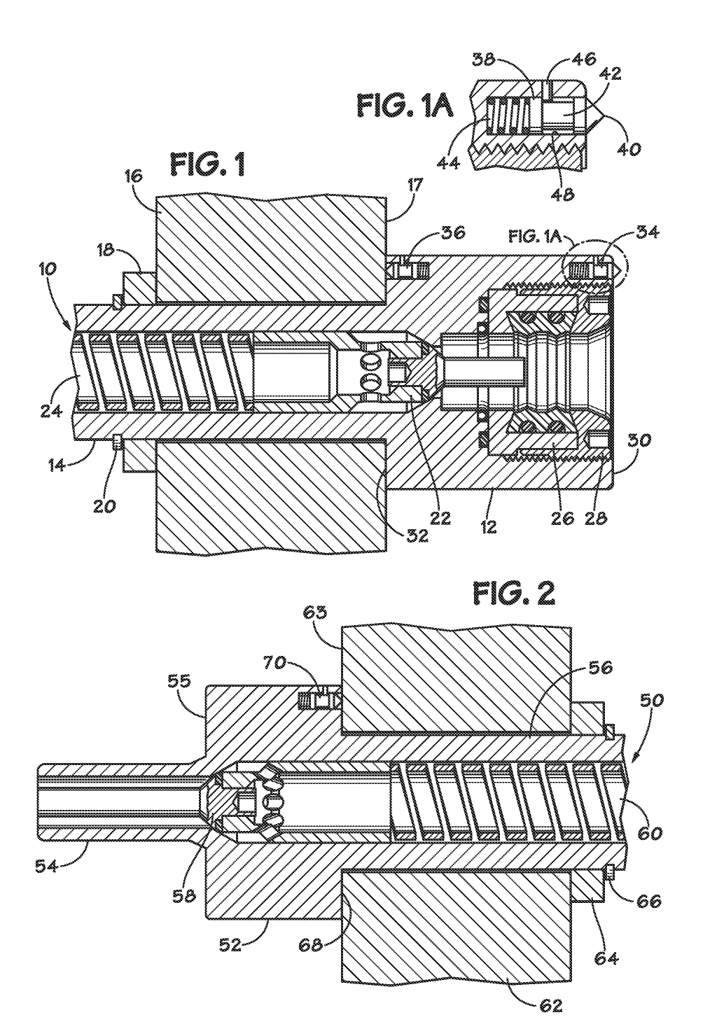

FIG. 1 depicts a female hydraulic coupling member 10 comprised of generally cylindrical body 12 and tail 14—a section of reduced diameter that facilitates mounting the coupling in a supporting structure such as a junction plate, tubing hanger, or the like. Shoulder 32 exists at the juncture of tail 14 and main body portion 12. A central axial bore passes through body 12 and tail section 14 providing a flow channel for hydraulic fluid. Optional poppet valve 22 and poppet spring 24 may be provided for blocking the flow channel when the coupling is disconnected. Coupling 10 may include a seal cartridge comprised of seal carrier 26 and externally-threaded shell 28 for holding and/or retaining one or more seals which engage the probe section of a corresponding male coupling member. The receiving chamber of coupling 10 may be internally threaded (as shown) to engage the seal cartridge.

In FIG. 1, female coupling member 10 is shown mounted in junction plate 16. In the illustrated embodiment, tail section 14 passes through a hole in junction plate 16. A first side of junction plate 16 abuts shoulder 32 on coupling 10 and an opposing side of junction plate 16 abuts thrust washer 18 which may be secured to tail section 14 by keeper 20 which may engage a circumferential groove on the exterior of tail section 14. When female coupling member 10 is connected to a corresponding male coupling member, leading face 30 of body section 12 abuts or is proximate a corresponding surface on the male member.

Electrical bonding contact 34 according to a first type illustrated in FIGS. 1-3 may be installed in blind hole 48, a generally cylindrical cavity in body 12 which is open to face 30. Electrical contact 34 may comprise contact body 38, a generally cylindrical element having section 42 of reduced diameter in the middle portion of the body and a conical projection at one end of the body which terminates at point 40. Contact spring 44 may be a compression spring which urges body 38 outwardly from cavity 48. Bonding spring 44 may be fabricated using any suitable resilient, electrically-conductive material. For use in the subsea environment, non-corrosive materials are preferred examples of which include stainless steel, Inconel, and brass.

Contact body 38 and spring 44 may be retained in cavity 48 by pin 46 inserted in a generally radial hole in coupling body 12. Pin 46 may be a roll pin and is preferably sized to engage the shoulder(s) formed by reduced diameter section 42. Cavity 48, spring 44 and contact body 48 are preferably sized and configured such that body 38 may slide axially in cavity 48 and spring 44 may be compressed sufficiently to permit point 40 to be substantially flush with face 30.

Coupling 10 may also comprise electrical bonding contact 36 in the face of shoulder 32 between main body 12 and tail section 14. Contact 36 is configured to contact face 17 of junction plate 16 when coupling 10 is inserted in plate 16 thereby electrically bonding coupling 10 to plate 16. Contact 36 may be configured similarly to contact 34 and interchangeable parts may be used. In the illustrated embodiment, contacts 34 and 36 are aligned both axially and radially in body 12, but such alignment is not necessary for their functionality. It yet other embodiments, contact 36 may be in surface 17 of junction plate 16.

A male hydraulic coupling member 50 designed for engagement with female coupling member 10 is shown in FIG. 2. FIG. 2 depicts a male hydraulic coupling member 50 comprised of generally cylindrical body 52, probe 54 and tail 56—a section of reduced diameter that facilitates mounting the coupling in a supporting structure such as a junction plate, tubing hanger, or the like. Shoulder 68 is formed at the juncture of tail 56 and main body portion 52. A central axial bore passes through body 52 and tail section 56 providing a passage for the flow for hydraulic fluid. Optional poppet valve 58 and poppet spring 60 may be provided for blocking the flow passage when the coupling is disconnected. Poppet valve 58 includes an actuator within probe section 54 which is sized and configured to bear against a corresponding actuator in the female member when the coupling members are joined together, thereby opening both poppet valves and permitting hydraulic fluid to flow through the coupling.

In FIG. 2, male coupling member 50 is shown mounted in manifold or junction plate 62. In the illustrated embodiment, tail section 56 passes through a hole in junction plate 62. A first side of junction plate 62 abuts shoulder 68 on coupling 50 and an opposing side of junction plate 62 abuts thrust washer 64 which may be secured to tail section 56 by keeper 66 which may engage a circumferential groove on the exterior of tail section 56. When male coupling member 50 is connected to a corresponding female coupling member (e.g., coupling member 10), leading face 55 of body section 52 abuts or is proximate a corresponding surface 30 on female member 10.

Male coupling member 50 includes bonding contact 70 in a generally cylindrical cavity within shoulder 68. Bonding contact 70 may be of the type described above in connection with contact 34 and shown in FIG. 1A. In use, bonding contact 70 establishes an electrically conductive path between coupling body 52 and junction plate 62 by contacting face 63 when coupling 50 is mounted in junction plate 62. It will be appreciated by those skilled in the art that, although coupling 52 may be in physical contact with plate 62 at a number of surfaces (e.g., shoulder 68, tail section 56 and thrust washer 64), due to surface contamination (marine organism growth, corrosion, etc.) such contact may not provide a low-resistance electrical connection between coupling 50 and junction plate 62. Bonding contact 70 is designed to pierce surface contamination with point 40 and thereby provide a relatively low-resistance electrical connection.

Contacts 34, 36 and 70 preferably have a sharp projection 40 (e.g., conical, wedge-shaped or pyramidal) to pierce any contamination or corrosion on the abutting surface of the opposing coupling member or junction plate and thereby establish a low-resistance electrical path among the two coupling members and their respective junction plates.

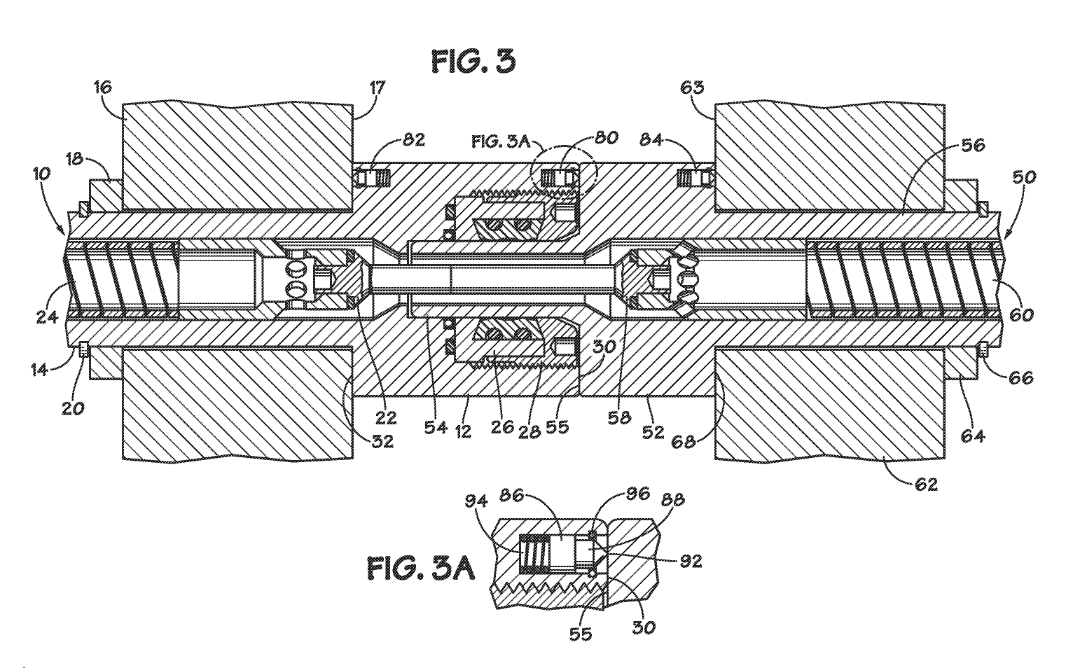

FIGS. 3, 4 and 5 illustrate an electrical bonding contact according to a second type. Bonding contact 80 is installed in the mating face 30 of the female coupling member and provides electrical bonding between the coupling members when the coupling is made-up. Bonding contact 82 is installed in shoulder 32 and provides bonding contact to plate 16. Bonding contact 84 is installed in shoulder 68 of male member 50 and provides bonding contact to plate 62.

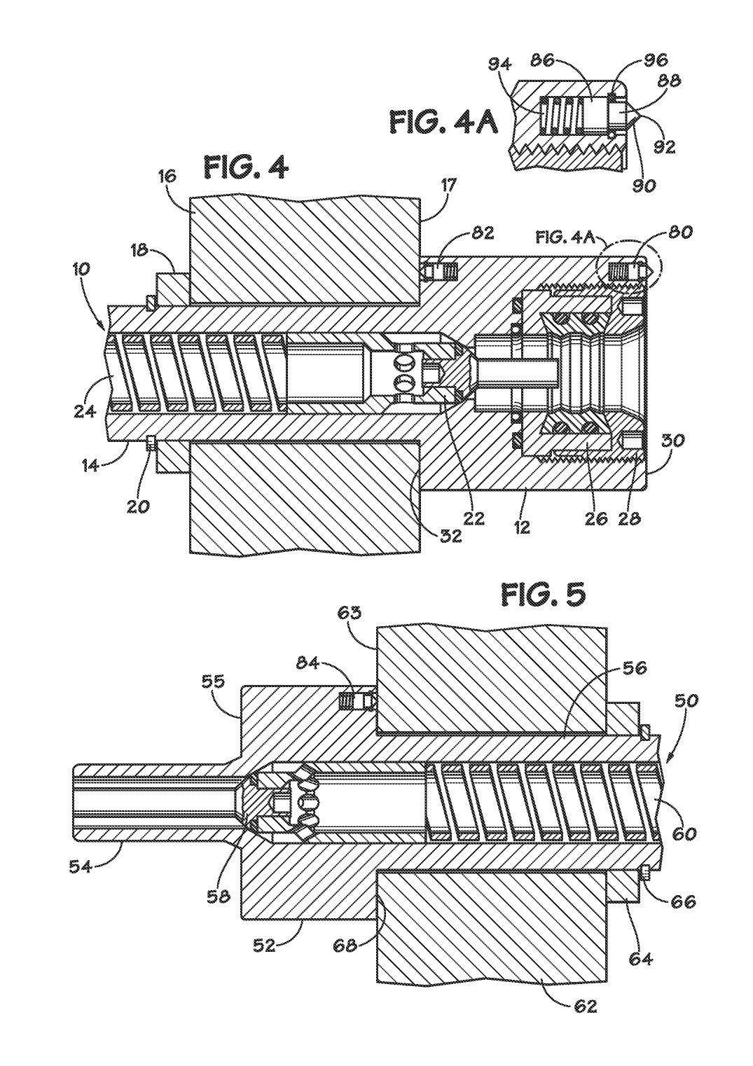

As illustrated in FIG. 4A, bonding contact 80 may be installed in blind hole 48, a generally cylindrical cavity in body 12 of coupling member 10 which is open to face 30. Electrical contact 80 may comprise contact body 86, a generally cylindrical element having section 88 of reduced diameter contiguous with a conical section 90 at one end of the body which terminates at point 92. Contact spring 94 may be a compression spring which urges body 86 outwardly from cavity 48. Bonding spring 94 may be fabricated using any suitable resilient, electrically-conductive material. For use in the subsea environment, non-corrosive materials are preferred examples of which include stainless steel, Inconel, and brass.

Contact body 86 and spring 94 may be retained in cavity 48 by keeper 96 inserted in a circumferential groove in the wall of cavity 48. Keeper 96 may be a snap ring and is preferably sized to engage the shoulder formed by reduced diameter section 88. Cavity 48, spring 94 and contact body 86 are preferably sized and configured such that body 86 may slide axially in cavity 48 and spring 94 may be compressed sufficiently to permit point 92 to be substantially flush with face 30. Bonding contacts 82 and 84 may be similarly constructed.

FIG. 3 shows coupling members 10 and 50 fully connected. In use, contact 80 makes electrical contact with the body of male member 50 when the two members are joined. As male probe 54 is inserted fully into the receiving chamber of the corresponding female member, contact body 86 is urged into cavity 48 as point 92 makes contact with the leading face 55 of male member 50. In this way, bonding device 80 does not interfere with complete make up of the coupling members while still providing for a reliable electrical connection. FIG. 3A shows the relative positions of contact body 86, spring 94, point 92 and face 55 with the coupling fully made-up. Using the apparatus of the invention, an electrical bonding path may be established from plate 16 through contact 82 to body 12, through contact 80 to body 52 and through contact 84 to plate 62. In this way, equal electrical potential may be established and maintained in an hydraulic connection system.

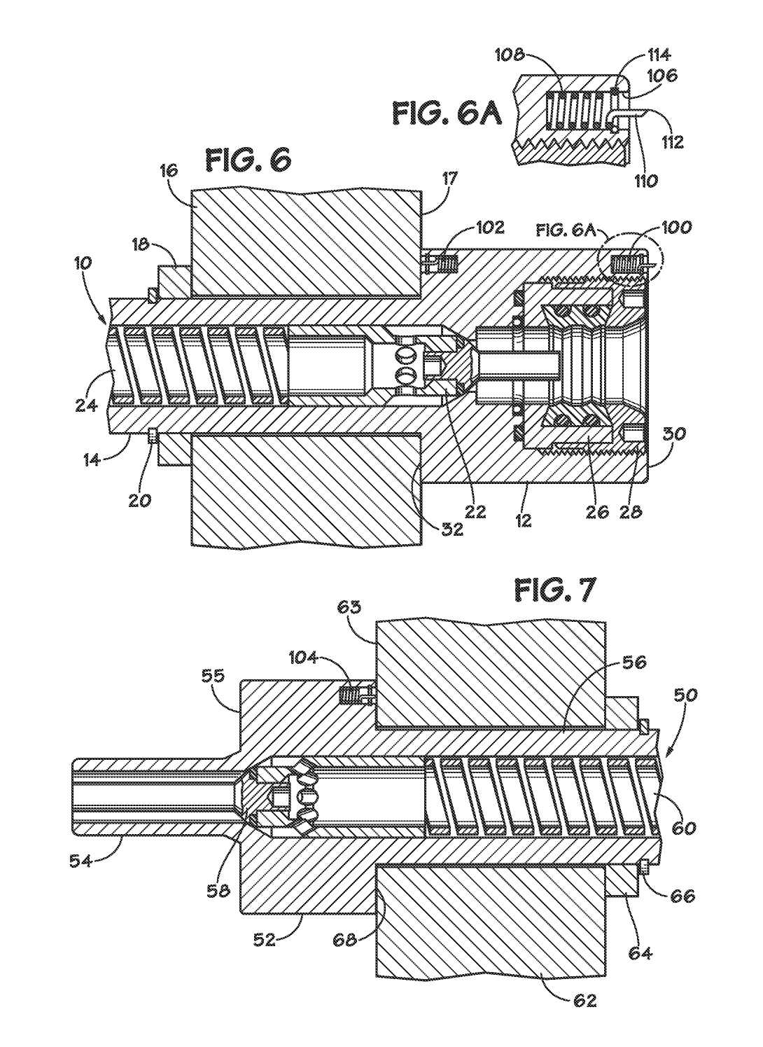

FIGS. 6, 6A and 7 illustrate an electrical bonding contact according to a third type. Bonding contact 100 is installed in the mating face 30 of female coupling member 10 and provides electrical bonding between the coupling members when the coupling is made-up. Bonding contact 102 is installed in shoulder 32 and provides bonding contact to plate 16. Bonding contact 104 is installed in shoulder 68 of male member 50 and provides bonding contact to plate 62.

As illustrated in FIG. 6A, bonding contact 100 may be installed in blind hole 48, a generally cylindrical cavity in body 12 of coupling member 10 which is open to face 30. Electrical contact 100 may comprise a helically-wound, electrically conductive, metal compression spring 108. End coil 110 of spring 108 may be bent to substantially align with the longitudinal axis of coil spring 108 and be provided with point 112. Bonding spring 108 may be fabricated using any suitable resilient, electrically-conductive material. For use in the subsea environment, non-corrosive materials are preferred examples of which include stainless steel, Inconel, and brass.

Contact spring 108 may be retained in cavity 48 by keeper 114 inserted in a circumferential groove in wall 106 of cavity 48. Keeper 114 may be a snap ring. Cavity 48, spring 108 and end coil 110 are preferably sized and configured such that spring 108 may be compressed sufficiently to permit point 112 to be substantially flush with face 30. Bonding contacts 102 and 104 may be similarly constructed. Resilient member 108 may take other forms—e.g., an elastomeric polymer having a conductive filler.

In use, point 112 of bonding contact 100 contacts the leading face 55 of corresponding male member 50 when the coupling is made up. Contact 100 retracts into cavity 48 compressing resilient member 108 as probe 54 of male member 50 is inserted fully into the receiving chamber of the female member. In this way, bonding device 100 does not interfere with full make up of the connection. The sharp point 112 in each of contacts 100, 102 and 104 is designed to penetrate surface contamination or corrosion on the opposing coupling member or junction plate and thereby create an electrical pathway through the coupling mounting system.

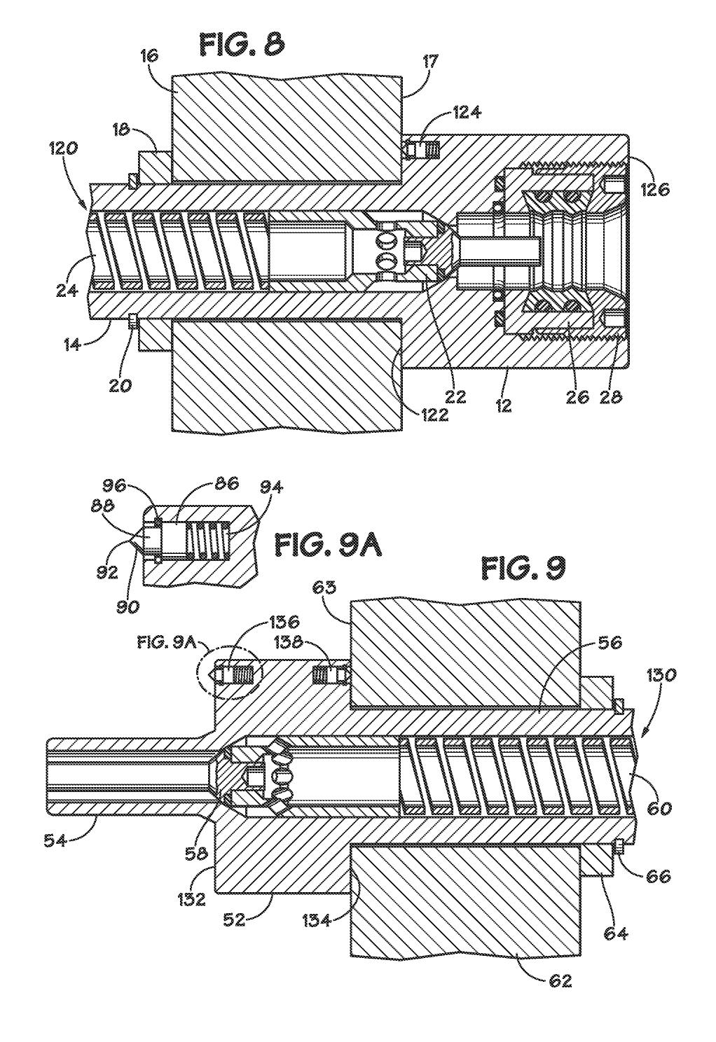

An alternative embodiment of the invention is shown in FIGS. 8, 9 and 9A. In this embodiment, female coupling member 120 is equipped with electrical bonding contact 124 in shoulder 122. Contact 124 provides electrical bonding to junction plate 16 when coupling member 120 is installed therein.

Male coupling member 130 (see FIG. 9) is provided with dual electrical bonding contacts 136 and 138. Contact 136 is installed in face 132 of male member 130 and is configured to contact face 126 of female member 120 when the coupling is fully made up. This contact provides electrical bonding between the male and female coupling members. Contact 138 is installed in shoulder 134 of male member 130 and is configured to contact surface 63 of junction plate 62 when coupling 130 is installed therein.

When coupling members 120 and 130 are fully made up, an electrical pathway is established from plate 62 through contact 138 to coupling 130, thence through contact 136 to coupling 120 and through contact 124 to plate 16. In this way, all conductive components of a coupling mounting system may be electrically bonded.

Although electrical bonding may be achieved using dual bonding contacts according to the present invention in either the male or the female coupling member, a coupling may comprise male and female members each having dual bonding contacts. In such a system, the contacts provided for contacting the opposing coupling member may be radially offset from one another to avoid the possibility of the contacts contacting one another when the coupling is made up (as such alignment might result in poorer electrical contact).

It will be appreciated by those skilled in the art that the invention may be retrofitted to existing coupling members. In certain embodiments (not shown), one of the dual bonding contacts may be provided in the seal retainer nut of a female coupling member. It is particularly convenient to retrofit female coupling members by simply replacing the seal retainer nut with a retainer nut according to the present invention. This may be accomplished by simply unscrewing the old retainer nut and replacing it with one incorporating a bonding contact according to the present invention.

Although the invention has been described in detail with reference to certain preferred embodiments, variations and modifications exist within the scope and spirit of the invention as described and defined in the following claims.

What is claimed is:

1. A male hydraulic coupling member comprising:
a generally cylindrical body having a first section proximate a first end adapted for connection to a female coupling member and a second section of reduced diameter proximate a second end adapted for connection to a hydraulic fluid conduit, with a first shoulder between the first and second sections;
a first cavity in the first shoulder open towards the second end;
a first electrically-conductive member having a first end within the first cavity and a second end moveable from a first position projecting from the first cavity to a second position substantially flush with the open end of the cavity;
a second cavity in the first end of the body open towards the first end;
a second electrically-conductive member having a first end within the second cavity and a second end moveable from a first position projecting from the second cavity to a second position substantially flush with the open end of the cavity.

2. A male hydraulic coupling member as recited in claim 1 wherein at least one of the electrically-conductive members comprises a spring.

3. A male hydraulic coupling member as recited in claim 2 wherein the spring is a helically-wound spring.

4. A male hydraulic coupling member as recited in claim 3 wherein the spring is fabricated from a metal selected from the group consisting of: stainless steel, Inconel and brass.

5. A male hydraulic coupling member as recited in claim 1 further comprising a keeper engaged to the wall of at least one of the cavities which limits the travel of the electrically-conductive member.

6. A male hydraulic coupling member as recited in claim 1 wherein the second end of at least one of the electrically-conductive members comprises a sharp point.

7. A male hydraulic coupling member as recited in claim 3 wherein the second end of the spring comprises a substantially right angle bend in the material forming the spring.

8. A male hydraulic coupling member as recited in claim 1 wherein at least one of the electrically conductive members comprises:
an electrically-conductive contact having a first end slidably disposed within the first or second cavity and a second end projecting from the cavity;
an electrically-conductive resilient member within the first or second cavity bearing against the contact and urging the contact in the direction of the open end of the cavity.

9. A male hydraulic coupling member as recited in claim 8 wherein the electrically-conductive resilient member comprises a spring.

10. A male hydraulic coupling member as recited in claim 9 wherein the spring is a helically-wound spring.

11. A male hydraulic coupling member as recited in claim 10 wherein the spring is fabricated from a metal selected from the group consisting of: stainless steel, Inconel and brass.

12. A male hydraulic coupling member as recited in claim 8 further comprising a keeper engaged to the wall of the first or second cavity which limits the travel of the electrically-conductive contact.

13. A male hydraulic coupling member as recited in claim 12 wherein the contact comprises a circumferential projection having a first end and a second end, the first end contacting the keeper to limit the travel of the contact and the second end bearing against the resilient member.

14. A male hydraulic coupling member as recited in claim 8 further comprising a pin in a radial hole in the wall of the first or second cavity, the pin configured to limit the travel of the contact.

15. A male hydraulic coupling member as recited in claim 8 wherein the projecting end of the contact comprises a sharp point.

16. An undersea hydraulic coupling system comprising:
a first junction plate;
a second junction plate in spaced-apart, substantially parallel relation to the first junction plate;
a male hydraulic coupling member mounted in the first junction plate and comprising:
a generally cylindrical body having a first section proximate a first end adapted for connection to a female coupling member and a second section of reduced diameter proximate a second end adapted for connection to a hydraulic fluid conduit, with a first shoulder between the first and second sections which shoulder bears against the first junction plate;
a first cavity in the first shoulder open towards the second end;
a first electrically-conductive member having a first end within the first cavity and a second end moveable from a first position projecting from the first cavity to a second position substantially flush with the open end of the cavity;
a second cavity in the first end of the body open towards the first end;
a second electrically-conductive member having a first end within the second cavity and a second end moveable from a first position projecting from the second cavity to a second position substantially flush with the open end of the cavity;
a female hydraulic coupling member mounted in the second junction plate and comprising:
a generally cylindrical body having a first section proximate a first end adapted for connection to the male coupling member and a second section of reduced diameter proximate a second end adapted for connection to a hydraulic fluid conduit, with a shoulder between the first and second sections which shoulder bears against the second junction plate;
a cavity in the shoulder open towards the second end;
an electrically-conductive member having a first end within the cavity and a second end moveable from a first position projecting from the cavity to a second position substantially flush with the open end of the cavity;
wherein the first electrically-conductive member in the male coupling member is in electrical contact with the first junction plate, the electrically-conductive member in the female coupling member is in electrical contact with the second junction plate and the second electrically-conductive member in the male coupling member is in electrical contact with the female coupling member when the coupling is fully made up.
